(19) United States
(12) Patent Application Publication
(10) Pub. No.: US 2020/0221464 A1
(43) Pub. Date: Jul. 9, 2020

(54) Techniques To Reduce Interference Between Uplink Channel and Adjacent Channel TDD Transmissions In Wireless Networks

(71) Applicant: Nokia Technologies Oy, Espoo (FI)

(72) Inventors: Sari Kaarina Nielsen, Espoo (FI); Antti Anton Toskala, Espoo (FI)

(21) Appl. No.: 16/624,802

(22) PCT Filed: Jun. 26, 2017
(86) PCT No.: PCT/EP2017/065726

§ 371 Date: Dec. 19, 2019

(51) Int. Cl. H04W 72/08; H04W 72/04; H04W 72/12; H04W 24/10; H04L 5/14

(52) U.S. Cl. CPC H04W 72/082; H04W 72/0446; H04L 5/1469; H04W 72/1215; H04W 24/10; H04W 72/1268

(57) ABSTRACT

A technique includes receiving, by a user device associated with a first cell from a base station associated with the first cell, information indicating the uplink/downlink configuration for one or more slots of an adjacent channel; determining, by the user device based on the received uplink/downlink configuration for one or more slots of the adjacent channel, whether or not the user device can detect uplink signals from one or more neighbor user devices associated with the neighbor cell on one or more uplink slots of the adjacent channel of the neighbor cell; and sending, by the user device associated with the first cell to the base station, a measurement report indicating whether or not the user device can detect uplink signals from one or more neighbor user devices associated with the neighbor cell on one or more uplink slots of the adjacent channel of the neighbor cell.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, above 6 GHz. For fifth generation wireless systems (5G), an access architecture for deployment of cellular radio equipment employing mmWave radio spectrum has been proposed. Other example spectrums may also be used, such as cmWave radio spectrum (3-30 GHz).

Adjacent-channel interference (ACI) may include interference caused by extraneous power from a signal in an adjacent channel (e.g., a different frequency or frequency band that may cause interference).

### SUMMARY

According to an example implementation, a method is provided for reducing interference with an adjacent channel, the method comprising: determining, by a base station associated with a first cell, an uplink/downlink configuration for one or more slots of an adjacent channel of a neighbor cell, the adjacent channel being adjacent in frequency or frequency band to a first channel used by the base station for uplink transmissions for the first cell; receiving, by the base station from a user device associated with the first cell, a measurement report indicating whether or not the user device can detect uplink signals from one or more neighbor user devices associated with the neighbor cell on one or more uplink slots of the adjacent channel of the neighbor cell; determining, by the base station based on the uplink/downlink configuration determined by the base station, slots of the adjacent channel where there are no downlink signals transmitted for the adjacent channel; scheduling, by the base station, the user device for uplink transmission on resources of the first channel during the one or more slots of the adjacent channel where there are no downlink signals transmitted for the adjacent channel of the neighbor cell; and scheduling, by the base station, the user device for uplink transmission on resources of the first channel during one or more downlink slots of the adjacent channel if the measurement report from the user device indicates that the user device cannot detect uplink signals from one or more neighbor user devices associated with the neighbor cell on one or more uplink slots of the adjacent channel of the neighbor cell.

According to an example implementation, an apparatus includes at least one processor and at least one memory including computer instructions that, when executed by the at least one processor, cause the apparatus to: determine, by a base station associated with a first cell, an uplink/downlink configuration for one or more slots of an adjacent channel of a neighbor cell, the adjacent channel being adjacent in frequency or frequency band to a first channel used by the base station for uplink transmissions for the first cell; receive, by the base station from a user device associated with the first cell, a measurement report indicating whether or not the user device can detect uplink signals from one or more neighbor user devices associated with the neighbor cell on one or more uplink slots of the adjacent channel of the neighbor cell; determine, by the base station based on the uplink/downlink configuration determined by the base station, slots of the adjacent channel where there are no downlink signals transmitted for the adjacent channel; schedule, by the base station, the user device for uplink transmission on resources of the first channel during the one or more slots of the adjacent channel where there are no downlink signals transmitted for the adjacent channel of the neighbor cell; and schedule, by the base station, the user device for uplink transmission on resources of the first channel during one or more downlink slots of the adjacent channel if the measurement report from the user device indicates that the user device cannot detect uplink signals from one or more neighbor user devices associated with the neighbor cell on one or more uplink slots of the adjacent channel of the neighbor cell.

According to an example implementation, a computer program product includes a computer-readable storage medium and storing executable code that, when executed by at least one data processing apparatus, is configured to cause the at least one data processing apparatus to perform a method including: determining, by a base station associated with a first cell, an uplink/downlink configuration for one or more slots of an adjacent channel of a neighbor cell, the adjacent channel being adjacent in frequency or frequency band to a first channel used by the base station for uplink transmissions for the first cell; receiving, by the base station from a user device associated with the first cell, a measurement report indicating whether or not the user device can detect uplink signals from one or more neighbor user devices associated with the neighbor cell on one or more uplink slots of the adjacent channel of the neighbor cell; determining, by the base station based on the uplink/downlink configuration determined by the base station, slots of the adjacent channel where there are no downlink signals transmitted for the adjacent channel; scheduling, by the base station, the user device for uplink transmission on resources of the first channel during the one or more slots of the adjacent channel where there are no downlink signals transmitted for the adjacent channel of the neighbor cell; and scheduling, by the base station, the user device for uplink transmission on resources of the first channel during one or more downlink slots of the adjacent channel if the measurement report from the user device indicates that the user device cannot detect uplink signals from one or more neighbor user devices associated with the neighbor cell on one or more uplink slots of the adjacent channel of the neighbor cell.

According to an example implementation, a method is provided for reducing interference with an adjacent channel, the method comprising: detecting, by a base station associated with a first cell, signals transmitted for an adjacent channel of neighbor cell to the first cell, the adjacent channel being adjacent in frequency or frequency band to a first channel used by the base station for uplink transmissions for the first cell; determining, by the base station based on the detecting, an uplink/downlink configuration for one or more slots of the adjacent channel of the neighbor cell; sending, by the base station to a user device associated with the first cell, information indicating the uplink/downlink configuration for one or more slots of the adjacent channel; receiving, by the base station from the user device associated with the first cell, a measurement report indicating that the user device cannot detect uplink signals from one or more neighbor user devices associated with the neighbor cell on one or more uplink slots of the adjacent channel of the neighbor cell; scheduling, by the base station, the user device for uplink transmission on resources of the first channel during one or more downlink slots of the adjacent channel based on the receiving of the measurement report from the user device that indicates that the user device cannot detect uplink signals from one or more neighbor user devices associated with the neighbor cell on one or more uplink slots of the adjacent channel of the neighbor cell.

According to an example implementation, an apparatus includes at least one processor and at least one memory including computer instructions that, when executed by the at least one processor, cause the apparatus to: detect, by a base station associated with a first cell, signals transmitted for an adjacent channel of neighbor cell to the first cell, the adjacent channel being adjacent in frequency or frequency band to a first channel used by the base station for uplink transmissions for the first cell; determine, by the base station based on the detecting, an uplink/downlink configuration for one or more slots of the adjacent channel of the neighbor cell; send, by the base station to a user device associated with the first cell, information indicating the uplink/downlink configuration for one or more slots of the adjacent channel; receive, by the base station from the user device associated with the first cell, a measurement report indicating that the user device cannot detect uplink signals from one or more neighbor user devices associated with the neighbor cell on one or more uplink slots of the adjacent channel of the neighbor cell; and, schedule, by the base station, the user device for uplink transmission on resources of the first channel during one or more downlink slots of the adjacent channel based on the receiving of the measurement report from the user device that indicates that the user device cannot detect uplink signals from one or more neighbor user devices associated with the neighbor cell on one or more uplink slots of the adjacent channel of the neighbor cell.

According to an example implementation, a computer program product includes a computer-readable storage medium and storing executable code that, when executed by at least one data processing apparatus, is configured to cause the at least one data processing apparatus to perform a method including: detecting, by a base station associated with a first cell, signals transmitted for an adjacent channel of neighbor cell to the first cell, the adjacent channel being adjacent in frequency or frequency band to a first channel used by the base station for uplink transmissions for the first cell; determining, by the base station based on the detecting, an uplink/downlink configuration for one or more slots of the adjacent channel of the neighbor cell; sending, by the base station to a user device associated with the first cell, information indicating the uplink/downlink configuration for one or more slots of the adjacent channel; receiving, by the base station from the user device associated with the first cell, a measurement report indicating that the user device cannot detect uplink signals from one or more neighbor user devices associated with the neighbor cell on one or more uplink slots of the adjacent channel of the neighbor cell; scheduling, by the base station, the user device for uplink transmission on resources of the first channel during one or more downlink slots of the adjacent channel based on the receiving of the measurement report from the user device that indicates that the user device cannot detect uplink signals from one or more neighbor user devices associated with the neighbor cell on one or more uplink slots of the adjacent channel of the neighbor cell.

According to an example implementation, a method is provided for reducing interference with an adjacent channel, the method comprising: receiving, by a user device associated with a first cell from a base station associated with the first cell, information indicating the uplink/downlink configuration for one or more slots of an adjacent channel, the adjacent channel being adjacent in frequency or frequency band to a first channel used by the base station for uplink transmissions for the first cell; determining, by the user device based on the received uplink/downlink configuration for one or more slots of the adjacent channel and based on an attempt by the user device to detect and measure signals on one or more uplink slots of the adjacent channel, whether or not the user device can detect uplink signals from one or more neighbor user devices associated with the neighbor cell on one or more uplink slots of the adjacent channel of the neighbor cell; and sending, by the user device associated with the first cell to the base station, a measurement report indicating whether or not the user device can detect uplink signals from one or more neighbor user devices associated with the neighbor cell on one or more uplink slots of the adjacent channel of the neighbor cell.

According to an example implementation, an apparatus includes at least one processor and at least one memory including computer instructions that, when executed by the at least one processor, cause the apparatus to: receive, by a user device associated with a first cell from a base station associated with the first cell, information indicating the uplink/downlink configuration for one or more slots of an adjacent channel, the adjacent channel being adjacent in frequency or frequency band to a first channel used by the base station for uplink transmissions for the first cell; determine, by the user device based on the received uplink/downlink configuration for one or more slots of the adjacent channel and based on an attempt by the user device to detect and measure signals on one or more uplink slots of the adjacent channel, whether or not the user device can detect uplink signals from one or more neighbor user devices associated with the neighbor cell on one or more uplink slots of the adjacent channel of the neighbor cell; and send, by the user device associated with the first cell to the base station, a measurement report indicating whether or not the user device can detect uplink signals from one or more neighbor user devices associated with the neighbor cell on one or more uplink slots of the adjacent channel of the neighbor cell.

According to an example implementation, a computer program product includes a computer-readable storage medium and storing executable code that, when executed by at least one data processing apparatus, is configured to cause the at least one data processing apparatus to perform a method including: receiving, by a user device associated with a first cell from a base station associated with the first cell, information indicating the uplink/downlink configuration for one or more slots of an adjacent channel, the adjacent channel being adjacent in frequency or frequency band to a first channel used by the base station for uplink transmissions for the first cell; determining, by the user device based on the received uplink/downlink configuration for one or more slots of the adjacent channel and based on an attempt by the user device to detect and measure signals on one or more uplink slots of the adjacent channel, whether or not the user device can detect uplink signals from one or more neighbor user devices associated with the neighbor cell on one or more uplink slots of the adjacent channel of the neighbor cell; and sending, by the user device associated with the first cell to the base station, a measurement report indicating whether or not the user device can detect uplink signals from one or more neighbor user devices associated with the neighbor cell on one or more uplink slots of the adjacent channel of the neighbor cell.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating interference between adjacent channels according to an illustrative example implementation.

FIG. 3 is a flow chart illustrating operation of a base station according to another example implementation.

FIG. 4 is a flow chart illustrating operation of a base station according to another example implementation.

FIG. 5 is a flow chart illustrating operation of a user device according to another example implementation.

FIG. 6 is a block diagram of a node or wireless station (e.g., base station/access point or mobile station/user device) according to an example implementation.

### DETAILED DESCRIPTION

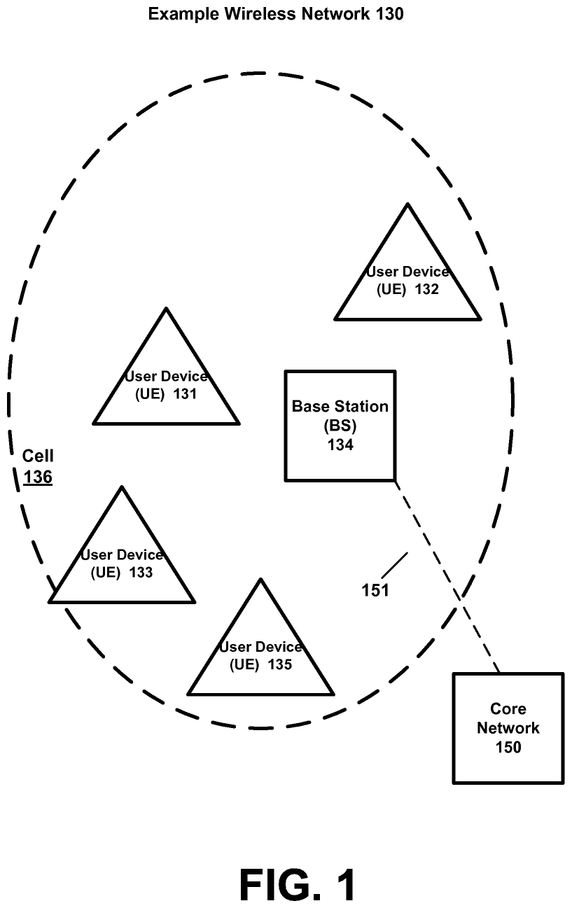

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e)Node B (eNB) may be also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a Si interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G (New Radio, or NR), ultra-reliability low latency communications (URLLC), Internet of Things (IoT), cmWave, and/or mmWave band networks, or any other wireless network. LTE, 5G, cmWave and mmWave band networks are provided only as illustrative examples, and the various example implementations may be applied to any wireless technology/wireless network.

Co-existence in wireless networks may include coordinating or controlling transmissions so as to reduce interference between different devices. For example, a common problem may include UE to UE interference, e.g., where a first UE of a first cell is transmitting and causing interference to a neighbor UE in a different cell or network. For example, in LTE TDD (time-division duplex), co-existence between operators may on synchronization between operators so that adjacent operators would send their uplink transmissions at the same time, and send downlink at the same time or only with small differences to control interference. However, it may not always be possible to synchronize uplink and downlink transmissions between adjacent cells or adjacent network, e.g., such as in the case of different wireless operators which may not communicate or coordinate their transmissions.

In addition, in an illustrative example or illustrative use case, a Supplementary Uplink (SUL) channel/frequency may be used, e.g., by 5G (NR) as a complimentary (or supplemental) uplink access link (including from random access point of view) to NR TDD (New Radio/5G time division duplex) and to NR FDD (New Radio/5G frequency division duplex), where the UE may even select PRACH (random access channel) resources either in the NR TDD/FDD uplink frequency or the SUL frequency. This may create new co-existence and interference scenarios between different TDD operators especially as NR SUL TDD frequency is expected to have either UL transmission. In some scenarios, a UE may select to use only a single uplink as SUL in addition to the downlink operation in TDD band in case the UE capability is limited or in case the TDD uplink coverage is not sufficient in such a band.

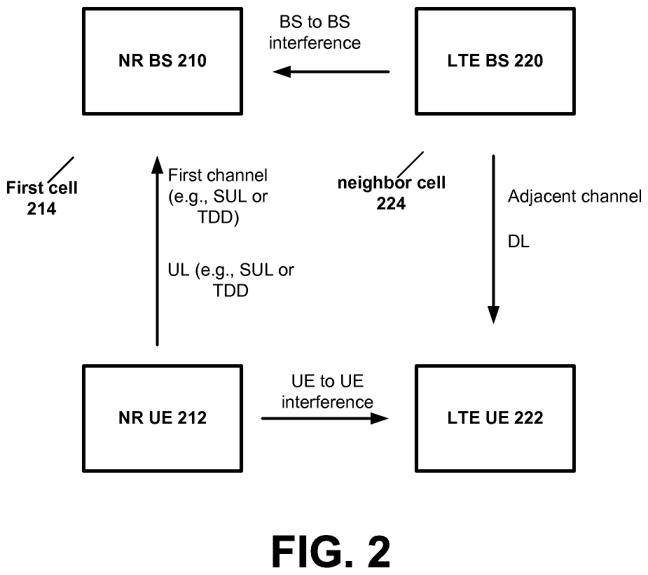

FIG. 2 is a diagram illustrating interference between adjacent channels according to an illustrative example implementation. For example, as shown in FIG. 2, a LTE BS 220 is in communication with (or connected to) a LTE UE 222. Also, a NR (5G) BS 210 is in communication with (or connected to) a NR (5G) UE 212. In an illustrative example, the NR BS 210 and NR UE 210 may be provided by a first wireless operator, while LTE BS 220 and LTE UE 222 may be provided by a second wireless operator (although alternatively, these systems may be provided by the same wireless operator as well). Also, the LTE BS 220 and LTE UE 222 may operate on a channel at, e.g., around 2.6 GHz, while the SUL channel, used by the NR BS 210 and NR UE 212 for some UL transmissions, for example, may operate at a channel of around 3.5 GHz. These carrier or channel frequencies are merely illustrative example, and different channels may be used. Also, NR BS 210 may provide wireless services via a first cell 214, while LTE BS 220 may provide wireless services through a neighbor cell 224, for example (e.g., cell 214 and cell 224 may be considered to be nearby cells or neighbor cells).

For example, a UE-to-UE interference may occur between UEs 212 and 222, while also BS-to-BS interference may occur between BSs 210 and 220. Other types of interference (e.g., BS-to-UE interference) may also occur. Adjacent-channel interference (ACI) may include interference caused by extraneous power from a signal in an adjacent channel. Adjacent channels may include a channel that is adjacent, e.g., in frequency, frequency band or carrier, for example.

For example, NR BS 210 and NR UE 212 may use either the SUL channel or a dynamic TDD UL/DL (uplink/downlink) channel (which may dynamically assign a slot or subframe as either uplink or downlink) may be transmitted via first channel, while LTE TDD BS 220 and LTE UE 222 may transmit on a second channel that is adjacent to the first channel. Therefore, for example, the UL transmission from NR UE 212 may cause adjacent channel interference to the UE 222, because these two UEs may be operating on adjacent channels. For example, different operators may not coordinate or synchronize their UL or DL transmissions. And, even if the LTE devices and NR devices are provided by the same operator, dynamic TDD (in either LTE or NR/5G) may change UL/DL configurations, e.g., such that synchronizing UL or DL transmissions between adjacent cells or networks may be difficult.

In some cases, one or more LTE UEs or LTE BSs may be unable to make changes or adapt to prevent adjacent channel interference, e.g., for one or more scenarios. Thus, it may be desirable for NR BS 210 and/or NR UE 212 to take steps to reduce interference with an adjacent channel(s). Adjacent channels may include a channel that is adjacent in frequency, frequency band or carrier, for example.

Therefore, according to an example implementation, the NR BS 210 and/or the NR UE 212 may perform one or more steps or operations to reduce adjacent channel interference. Various example implementations will now be described, by way of illustrative examples. Several operations will now be described, which may be performed by NR BS 210 and/or NR UE 212, for example, as follows, by way of illustrative example. Operations 1)-5) are described below to provide an illustrative example implementation. The illustrative example of operations 1)-5) may describe a method of reducing interference with an adjacent channel (e.g., a method of reducing interference from a first channel of first cell 214 to an adjacent channel of neighbor cell 224). The cells 214 and 224 may be the same radio access technology (RAT), such as LTE, NR(5G), etc., or may be different RATs.

1) NR BS 210, associated with (or providing wireless services via) a first cell 214, may determine an uplink/downlink (UL/DL) configuration for one or more slots or subframes of an adjacent channel of a neighbor cell 224. For example, NR BS 210 may determine an UL/DL configuration for one or more slots or subframes of the adjacent channel used by LTE BS 220 and LTE UE 222. For example, the TDD channel used by the LTE BS 220 and UE 222 may be considered to be adjacent to the SUL channel (and/or dynamic TDD channel) used by the NR BS 210 and NR UE 212. For example, a first channel may be considered to be adjacent to a second channel if, e.g., the signals from the first channel may cause interference (e.g., adjacent channel interference) with the second channel, or if signals from the second channel may cause interference with the first channel. According to an example implementation, a frame may include a plurality of subframes (e.g., 10 subframes), and may include a plurality of slots (e.g., 20 slots). Therefore, there may be 2 (or other number) of slots per subframe, in an illustrative example. The BS 210 determining an UL/DL configuration for the adjacent channel of a neighbor cell 224 may include, e.g., determining, for one or more slots (or subframes or other portions of a frame) of the adjacent channel, whether the slot is an uplink slot (e.g., including uplink data or signals) or a downlink slot (e.g., including downlink data or signals). As used herein, the term slot may include, as some illustrative examples: slots and/or or subframes, and/or other portion(s) of a frame, for example.

The operation 1) (determining a UL/DL configuration for one or more slots or subframes of an adjacent channel of a neighbor cell 224) may 1A) be directly performed by NR BS 210, or 1B) may be performed by NR UE 212 and then reported or sent by NR UE 212 to NR BS 210, for example.

1A) For example, NR BS 210 may detect signals transmitted for the adjacent channel of neighbor cell 224, and then determine, based on the detected signals, an UL/DL configuration (e.g., determine whether a slot is an UL slot or a DL slot) for one or more slots of the adjacent channel of the neighbor cell 224. A DL slot may be a slot that includes DL (downlink) information (e.g., transmission of DL control signals and/or DL data from a BS to a UE), while an UL (uplink) slot may be a slot that includes UL information (e.g., transmission of UL control signals and/or UL data from a UE to a BS) For example, BS 210 may detect signals in the adjacent channel of the neighbor cell 224 that are typically transmitted as part of an UL slot or typically transmitted as part of a DL slot, to determine whether a slot is an UL slot or a DL slot. For example, If NR BS 210 detects synchronization signals (e.g., including primary synchronization signals (PSS), secondary synchronization signals (SSS) and/or channel state information-reference signals (CSI-RS)) for a slot, then this indicates that the slot is a DL slot, e.g., because these signals are typically transmitted downlink by a BS within a DL slot. On the other hand, if NR BS 210 detects sounding reference signals (SRS) signals transmitted by a UE for a slot, then this indicates that the slot is an UL slot because SRS signals are UL signals transmitted within an UL slot. These are just a few examples of signals that may be detected and/or measured to determine whether a slot is an UL or DL slot, and other signals or detection mechanisms may be used. In this manner, for example, by detecting specific signals, the NR BS 210 may determine the UL/DL configuration (e.g., which slots are UL slots and which slots are DL slots) for the adjacent channel of the neighbor cell 224. These are some illustrative signals and techniques that may be used.

iB) Alternatively, the NR UE 212 may determine a UL/DL configuration for one or more slots or subframes of the adjacent channel of a neighbor cell 224, and then may report this UL/DL configuration of the adjacent channel to NR BS 210, for example. For example, the NR UE 212 may detect one or more signals for each slot of the adjacent channel determine, and then determine, based on these detected signals, an UL/DL configuration (e.g., determine whether a slot is an UL slot or a DL slot) for one or more slots of the adjacent channel of the neighbor cell 224 (similar to the techniques described for NR BS for operation 1A)). Thus, the NR BS 210 may receive, from the NR UE 212, a measurement report including UL/DL information (e.g., indicating one or more slots as UL slots, and indicating one or more slots as DL slots) with respect to the adjacent channel of the neighbor cell 224.

In addition, the NR BS 210 may notify or inform the NR UE 212 of the UL/DL configuration of the adjacent channel of the neighbor cell 224, e.g., to assist the NR UE with detection and measurement of UL signals (during the indicated UL slots of the neighbor cell 224) of the neighbor cell 224. Also, the NR UE 212 may attempt to detect the UL/DL configuration of the adjacent channel of the neighbor cell 224, and then the NR UE 212 may notify the NR BS 210 of such detected UL/DL configuration of the adjacent channel of the neighbor cell 224, which may be particularly helpful to the NR BS 210 in the event the NR BS 210 is unable to detect the UL/DL configuration of the adjacent channel of the neighbor cell 224.

Operation 2) may include receiving, by the NR BS 210 from NR UE 212 associated with the first cell 214, a measurement report indicating whether or not the user device can detect uplink signals from one or more neighbor user devices associated with the neighbor cell on one or more uplink slots of the adjacent channel of the neighbor cell. For example, the NR UE 212 may either determine one or more UL slots of the adjacent channel, or the NR UE 212 may receive UL/DL configuration information (e.g., identifying at least one or more UL slots of the adjacent channel). Then, for example, for at least these one or more UL slots of the adjacent channel, the NR UE 212 may attempt to detect and/or measure signals on one or more UL slots of the adjacent channel of the neighbor cell 224. In this manner, the NR UE 212 may detect and/or measure signals transmitted by a neighbor UE(s) 222, e.g., to determine if the NR UE 212 whether or not the NR UE 212 can detect UL signals from one or more neighbor UEs associated with neighbor cell 224 for one or more UL slots of the adjacent channel of the neighbor cell 224. For example, if the NR UE 212 is able to detect UL signals transmitted by a neighbor UE 222, then this likely indicates that UL transmissions from the NR UE 212 would likely interfere with (e.g., adjacent channel interference) the reception operation of neighbor UE 222 (e.g., UL signals from NR UE 212 would likely be received by neighbor UE 222 and thus would likely interfere with UE 222 attempting to receive DL transmissions from neighbor BS 220, for example). Thus, in order to determine whether UL transmissions from NR UE 212 may be scheduling during (or overlapping with) DL slots of the neighbor cell 224, the NR BS 210 may first determine whether NR UE 212 can detect UL transmissions from neighbor UE 222. This is because, for example, BSs 210 and 220 may be relatively far apart (e.g., causing very little interference between these BSs, for example), while, in some situations, NR UE 212 of first cell 214 and LTE UE 222 of the neighbor cell 224 may be relatively near each other (which may cause interference between these cells and/or adjacent channels). Thus, at operation 2), the NR BS 210 of the first cell 214 may receive a measurement report from NR UE 212 indicating whether or not the NR UE 212 can detect UL signals from one or more neighbor UEs (e.g., such as LTE UE 222) on one or more UL slots of the adjacent channel of the neighbor cell 224.

At operation 3), NR BS 210 determines. based on the uplink/downlink configuration (UL/DL split) of the adjacent channel, slots of the adjacent channel where there are no downlink signals transmitted for the adjacent channel. For example, the slots where there are no DL signals may include UL slots of the adjacent channel, or other slots of the adjacent channel where there are no DL signals/transmissions.

Operation 4) may include scheduling, by the NR BS 210, the NR UE 212 for uplink transmission on resources of the first channel/first cell 214 during the one or more slots of the adjacent channel (of the neighbor cell 224) where there are no downlink signals transmitted for the adjacent channel of the neighbor cell. Thus, for example, operation 4) may include NR BS 210 scheduling (including sending an UL grant or semi-static UL configuration) the NR UE 212 for UL transmissions during one or more UL slots of the adjacent channel of the neighbor cell 224. Thus, for example, operation 4) may be same as or similar to performing UL synchronization between adjacent cells or adjacent channels, e.g., wherein UL transmissions are synchronized (UL signals transmitted at same time or during same slots/subframes, e.g., to avoid adjacent channel interference). For example, the slots of the NR first cell 214 may be slot-aligned or not slot-aligned with the slots of the adjacent channel/neighbor cell 224. If slot-aligned, then operation 4) includes scheduling NR UE 212 for UL transmission during one or more UL slots of the adjacent channel of neighbor cell 224. If these cells are not slot-aligned, then the NR BS 210 may schedule the NR UE 212 to transmit UL signals on first cell 214 during any of the NR/first cell 214 slots or time instants in which there are no DL signals detected for the adjacent channel or neighbor cell 224.

Operation 5) may include the NR BS 210 scheduling, the NR UE 212 for UL transmission on resources of the first cell 214 during one or more DL slots of the adjacent channel if the measurement report from the NR UE 212 indicates that the NR UE 212 cannot detect UL signals from one or more neighbor UEs (e.g., including LTE UE 222) associated with the neighbor cell on one or more uplink slots of the adjacent channel of the neighbor cell. As noted, the NR BS may schedule NR UE 212 for UL transmissions on DL slots of the adjacent channel of the neighbor cell 224 if the NR UE 212 cannot detect UL signals/transmissions from one or more neighbor UEs. Thus, if the transmissions from NR UE 212 are not likely to interfere with the UE signal reception by neighbor UEs via neighbor cell 224 (during DL slots of the neighbor cell), then these time periods of the DL slots of the neighbor cell 224 may be used for UL transmission within NR first cell 214 only for any NR UE (e.g., NR UE 212) that cannot detect UL signals from neighbor UE(s) of neighbor cell 224. On the other hand, if a NR UE can detect an UL signal from at least one neighbor UE of the adjacent channel of the neighbor cell, then the time periods of the DL slots of the neighbor cell 224 are not (or should not be) available, for example, to such NR UE for UL transmission, since such UL transmission from the NR UE would likely cause interference with the detected neighbor UE of adjacent channel of the neighbor cell 224. Thus, for example, the scheduling of a NR UE for UL transmission at operation 5) is UE-specific, based on the detection of UL signals on the neighbor cell, as detected by that NR UE. This is because each UE may be in a different physical location, and may or may not be able to detect other UEs from the neighbor cell, e.g., depending on its relative location to the neighbor UEs of the neighbor cell 224.

According to an example implementation, the measurement report received by the NR BS 210 from NR UE 212 may be, for example, based on UE signal measurements of one or more uplink slots of the adjacent channel, wherein uplink slots of the adjacent channel for the neighbor cell 224 may be indicated based on UL/DL configuration of the adjacent channel that is either detected by the NR UE 212 or sent by the NR BS 210 to the NR UE 212.

According to an example implementation, the first channel (provided by first cell 214), which may be adjacent to the adjacent channel of the neighbor cell 224, may be at least one of the following: a supplementary uplink channel used by the base station for uplink transmissions for the first cell; and a time-division duplex (TDD) channel with dynamic uplink/downlink allocations.

Also, according to an example implementation, first cell 214, the NR BS 210, and NR UE 212 and the first channel are part of a first network for a first wireless operator, and the LTE BS 220, LTE UE 222, the adjacent channel and neighbor cell 224 re part of a second network for a second wireless operator that is different from the first wireless operator. Thus, the wireless operators may be the same operator, or the operators for cells 214 and 224 may be different operators.

Operations 6)-8) are now described below according to another illustrative example implementation. The illustrative example of operations 6)-8) may describe a method of reducing interference with an adjacent channel (e.g., a method of reducing interference from a first channel of first cell 214 to an adjacent channel of neighbor cell 224). The cells 214 and 224 may be the same radio access technology (RAT), such as LTE, NR(5G), etc., or may be different RATs.

Operation 6) may include a NR UE 212 (associated with or connected to a first cell 214 and first channel) receiving (e.g., from NR BS 210) information indicating the UL/DL configuration for one or more slots of an adjacent channel of the neighbor cell 224. The adjacent channel may be, e.g., adjacent in frequency or frequency band to a first channel used by the NR BS 210 for uplink transmissions for the first cell 214.

Operation 7) may include determining, by the NR UE 210 based on the received UL/DL configuration (which may indicate one or more UL slots of the adjacent channel of neighbor cell 224 that should be detected or measured by the NR UE 212) for one or more slots of the adjacent channel and based on an attempt by the NR UE 212 to detect and measure signals on one or more UL slots of the adjacent channel, whether or not the NR UE 212 can detect UL signals from one or more neighbor UEs (e.g., from neighbor UE 222) associated with the neighbor cell 224 on one or more UL slots of the adjacent channel of the neighbor cell 224. As noted, if NR UE 212 is (near enough to UE 222 to be) able to detect UL signals from neighbor UE 222 on the adjacent channel of the neighbor cell 224, this indicates that UL transmissions by such nearby/detecting NR UE 212, if transmitted during DL slots of the adjacent channel, would likely cause interference with neighbor UE's attempt to receive DL transmissions from BS 220, for example. Thus, according to an example implementation, UL transmissions from the NR UE 212 should be avoided during neighbor cell DL slots if the NR UE 212 is able to detect UL transmissions on one or more neighbor UEs for the adjacent channel of the neighbor cell.

Operation 8) includes the NR UE 212 (associated with the first cell 214 and via a first channel that may be a SUL channel or a TDD channel) to the NR BS 210 a measurement report indicating whether or not the NR UE 212 can detect UL signals from one or more neighbor UEs (e.g., UE 222) associated with the neighbor cell 224 on one or more UL slots of the adjacent channel of the neighbor cell 224.

In addition to the operations 6)-8), some further operations may include the following:

Operation 9) may include receiving (e.g., based on the NR UE 212 being unable to detect UL transmission from one or more neighbor UEs for neighbor cell 224), by the NR UE 212 from the NR BS 210, either an uplink grant or an uplink configuration for a semi-static resource allocation, indicating resources of the first channel (within first cell 214) for UL transmission during (or at least partially overlapping time instants of) one or more DL slots of the adjacent channel of the neighbor cell 224.

Operation 9), for example, may include receiving, by the NR UE 212 from the NR BS 210, either an uplink grant or an uplink configuration for a semi-static resource allocation, indicating resources of the first channel (within first cell 214) for UL transmission during (or overlapping with) one or more DL slots of the adjacent channel of the neighbor cell 224, if the NR UE 212 cannot detect UL signals from one or more neighbor UEs associated with the neighbor cell 224 on one or more UL slots of the adjacent channel of the neighbor cell.

Alternatively, operation 10 may include receiving, by the NR UE 212 from the NR BS 210, either an uplink grant or an uplink configuration for a semi-static resource allocation, indicating resources of the first channel/first cell 214 for UL transmission only during one or more UL slots, and not during one or more DL slots (as that would cause interference), of the adjacent channel of the neighbor cell 224 if the NR UE 212 can detect UL signals from one or more neighbor UEs (e.g., neighbor UE 222) associated with the neighbor cell 224 on one or more UL slots of the adjacent channel of the neighbor cell 224. Thus, according to an example implementation, only time periods of the UL slots (or non-DL slots) of the adjacent channel of the neighbor cell 224 may be used for NR UE 212 UL transmissions for the first cell if the NR UE 212 can detect UL transmission from one or more neighbor UEs 222 for the adjacent channel of the neighbor cell.

Some additional example implementations will now be described. One or more various example implementations may provide a solution for avoiding (or at least reducing) co-existence issues between dynamic NR TDD (New Radio/5G time division duplex) Supplementary UL (SUL) and LTE TDD or NR TDD with more static DL/UL allocations. This type of co-existence solutions may be, at least in some cases, particularly needed between different operators and to protect legacy LTE TDD victim system and UEs.

For example, the good co-existence between operators and especially interference towards victim LTE TDD may be improved or assisted with one or more of the following actions by NR TDD BS and NR TDD UE using NR TDD SUL on a given frequency band (as an example frequency band):

1. NR BS detects and measures what is neighbor operator's UL/DL configuration, e.g., what slots are used for DL and which slots are used for UL on the adjacent frequency typically on the same frequency band.

2. NR UE also detects and measures what is neighbor operator's UL/DL configuration, e.g., what slots are used for DL and which ones for UL on the adjacent frequency typically on the same frequency band. NR BS may provide sufficient assistance to NR UE, e.g., through signaling that may indicate what frequency to detect for neighbor operator's operations.
NR BS and NR UE may be hearing/detecting different neighbor operators base stations due to uncoordinated deployments between the operators. Thus, it may be, at least in some cases, beneficial that both NR BS and NR UE attempt or try to detect neighbor operator's TDD UL/DL configuration. In this way an increased likelihood is provided that neighbor operator's signal and its DL/UL are detected if there is any in the neighborhood.

3. If neither NR BS nor NR UE detects any neighbor operator's TDD signal and operations on the adjacent carrier, NR BS can safely use any slots (UL or DL) for UL transmission without risking to cause interference to the victim neighbor operator.

4. If either NR BS or NR UE detects neighbor operator's TDD UL/DL configuration, NR BS can safely use all the neighbor operator's UL slots for its UL transmission to ensure similarly synchronized operations as assumed between LTE TDD operators and thus avoiding co-existence issues.

5. Next in order to allow UL transmission of NR UE also during some of neighbor operator's DL slots the following actions may be taken:

The NR UE attempts to detect during neighbor operator's UL slots whether it can hear any UE's transmission in the neighbor operator's system and frequency. The NR UE knows the neighbor operator's UL slots either based on its own earlier measurements or alternatively based on information received from the NR BS during signaling (e.g., radio resource control/RRC signaling). These detections may typically need to be sufficiently long or sufficiently many separate detections are done, in order to make sure that the NR UE does not just happen to try to do the detection during the idle transmission periods of neighbor operator's UE.

If the NR UE does not hear/detect any neighbor operator UE's transmission after several attempts over period of time and neighbor operator has relatively symmetric DL/UL allocations, e.g., not DL broadcast only, the NR UE informs the NR BS (that it cannot detect neighbor operator UE's transmission) and then the NR BS can take many of the neighbor operator's DL slots for UL use on its supplementary UL for a given UE without creating too severe co-existence issue.
If the NR UE hears/detects neighbor operator UE's transmission based on its detection (described above), the NR UE reports this to the network/NR BS and then network/NR BS cannot use neighbor operator's UL slots for NR UL data transmission of this particular NR UE. However, UL transmission could be possible for another NR UE in another location and thus, not causing any interference to the neighbor operator's UEs.

Additionally, NR UE may need to detect a sync (synchronization) signal from neighbor operator and then the NR UE does not send any UL transmission when the synchronization and P-BCH (physical broadcast channel) signals are being transmitted.

Some further example details are now described for another example implementation(s):

In an example implementation:
NR UE determines (if it hears/detects) signals or UL/DL split from the neighboring cell(s) (also eNodeB/NR BS to measure this)
Those time instants where no neighbor cell downlink activity is detected can be used as supplemental uplink for all UEs
Rest of the resources (where downlink activity of neighbor cell is to take place) can be used as uplink resources for those NR UEs that do not hear/detect the potentially interfered neighbor BS/cell downlink transmission
The uplink allocation for NR UEs may leave a periodic break from any uplink use, which would be taking place when the neighboring BTS is sending critical information (like MIB transmission). Thus, NR BS may avoid scheduling NR UEs during time periods when neighbor cell may be transmitting critical broadcast information such as transmission of system information or management information blocks.
This may ensure/assist idle mode devices of neighbor cell are able to receive (without interference) such system/management information and thus more likely to remain/stay connected to the network/neighbor cell as they can synchronize for the BS signal (these breaks would be when synchronization signals, such as primary or secondary synch signals, e.g., PSS/SSS periodic signals are sent in case of LTE TDD)
TDD carriers in one carrier frequency may be assumed, for example, to have frame synchronization
From UE point of view: this may provide the measurement report (of detected UL/DL configurations and/or detected signals)
NR UE may receive an indication then from the NR BS, of which uplink resources it may use on supplemental uplink/SUL channel (uplink grant is one but which time slots are available for PUCCH use to report HARQ ACK/NACK or CQI)
And then NR UE follows this instruction for the uplink resource usage
It could be also instructed to send all ACK/NACK signaling on the Supplemental uplink (SUL channel) for reduced latency (which is otherwise may be a problem such as with e.g. 3.5 GHz if there are a lot of Downlink allocation to reach high data rates), then smaller bandwidth TDD carrier on e.g. 2.6 GHz may be used as supplemental uplink.

### Example 1

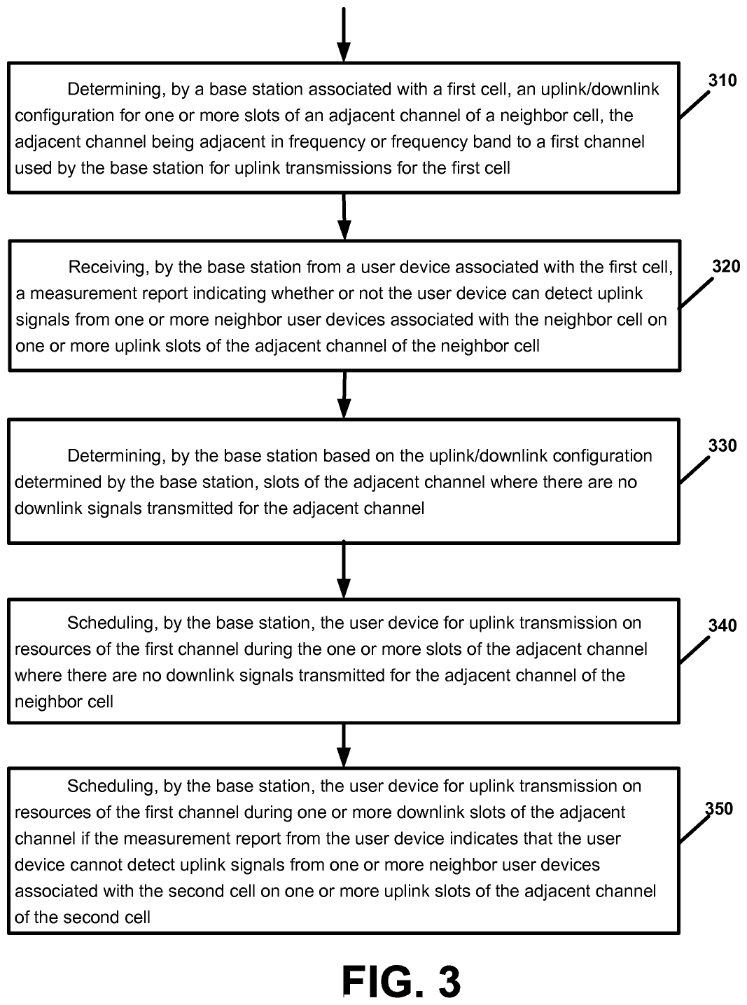

FIG. 3 is a flow chart illustrating operation of a base station according to an example implementation. Operation 310 includes determining, by a base station associated with a first cell, an uplink/downlink configuration for one or more slots of an adjacent channel of a neighbor cell, the adjacent channel being adjacent in frequency or frequency band to a first channel used by the base station for uplink transmissions for the first cell. Operation 320 includes receiving, by the base station from a user device associated with the first cell, a measurement report indicating whether or not the user device can detect uplink signals from one or more neighbor user devices associated with the neighbor cell on one or more uplink slots of the adjacent channel of the neighbor cell. Operation 330 includes determining, by the base station based on the uplink/downlink configuration determined by the base station, slots of the adjacent channel where there are no downlink signals transmitted for the adjacent channel. Operation 340 includes scheduling, by the base station, the user device for uplink transmission on resources of the first channel during the one or more slots of the adjacent channel where there are no downlink signals transmitted for the adjacent channel of the neighbor cell. Operation 350 includes scheduling, by the base station, the user device for uplink transmission on resources of the first channel during one or more downlink slots of the adjacent channel if the measurement report from the user device indicates that the user device cannot detect uplink signals from one or more neighbor user devices associated with the neighbor cell on one or more uplink slots of the adjacent channel of the neighbor cell.

### Example 2

According to an example implementation of example 1, wherein the measurement report received from the user device is based on user device signal measurements of one or more uplink slots of the adjacent channel, wherein uplink slots of the adjacent channel are indicated based on uplink/downlink configuration of the adjacent channel that is either detected by the user device or sent by the base station to the user device.

### Example 3

According to an example implementation of any of examples 1-2, wherein the scheduling, by the base station, the user device for uplink transmission on resources of the first channel during the one or more slots of the adjacent channel where there are no downlink signals transmitted for the adjacent channel of the neighbor cell comprises: scheduling, by the base station, the user device for uplink transmission on resources of the first channel during one or more uplink slots of the adjacent channel.

### Example 4

According to an example implementation of any of examples 1-3, wherein the first channel comprises at least one of the following: a supplementary uplink channel used by the base station for uplink transmissions for the first cell; and a time-division duplex (TDD) channel with dynamic uplink/downlink allocations.

### Example 5

According to an example implementation of any of examples 1-4, wherein the determining an uplink/downlink configuration for one or more slots of an adjacent channel of a neighbor cell comprises: determining, for one or more slots of the adjacent channel of the neighbor cell, whether the slot is an uplink slot or a downlink slot.

### Example 6

According to an example implementation of any of examples 1-5, wherein the determining an uplink/downlink configuration for one or more slots of the adjacent channel of the neighbor cell comprises: detecting, by the base station associated with the first cell, signals transmitted for the adjacent channel of the neighbor cell; and determining, by the base station based on the detecting, an uplink/downlink configuration for one or more slots of the adjacent channel of the neighbor cell.

### Example 7

According to an example implementation of any of examples 1-6, wherein the determining an uplink/downlink configuration for one or more slots of the adjacent channel of the neighbor cell comprises: receiving by the base station from the user device, a measurement report including uplink/downlink information with respect to the adjacent channel of the neighbor cell.

### Example 8

According to an example implementation of any of examples 1-7, and further comprising: sending, by the base station to the user device associated with the first cell, information indicating the uplink/downlink configuration for one or more slots of the adjacent channel.

### Example 9

According to an example implementation of any of examples 1-8, wherein the first cell and the first channel are part of a first network for a first wireless operator, and the neighbor cell is part of a second network for a second wireless operator that is different from the first wireless operator.

### Example 10

An apparatus comprising means for performing a method of any of examples 1-9.

### Example 11

An apparatus comprising at least one processor and at least one memory including computer instructions that, when executed by the at least one processor, cause the apparatus to perform a method of any of examples 1-9.

### Example 12

An apparatus comprising a computer program product including a non-transitory computer-readable storage medium and storing executable code that, when executed by at least one data processing apparatus, is configured to cause the at least one data processing apparatus to perform a method of any of examples 1-9.

### Example 13

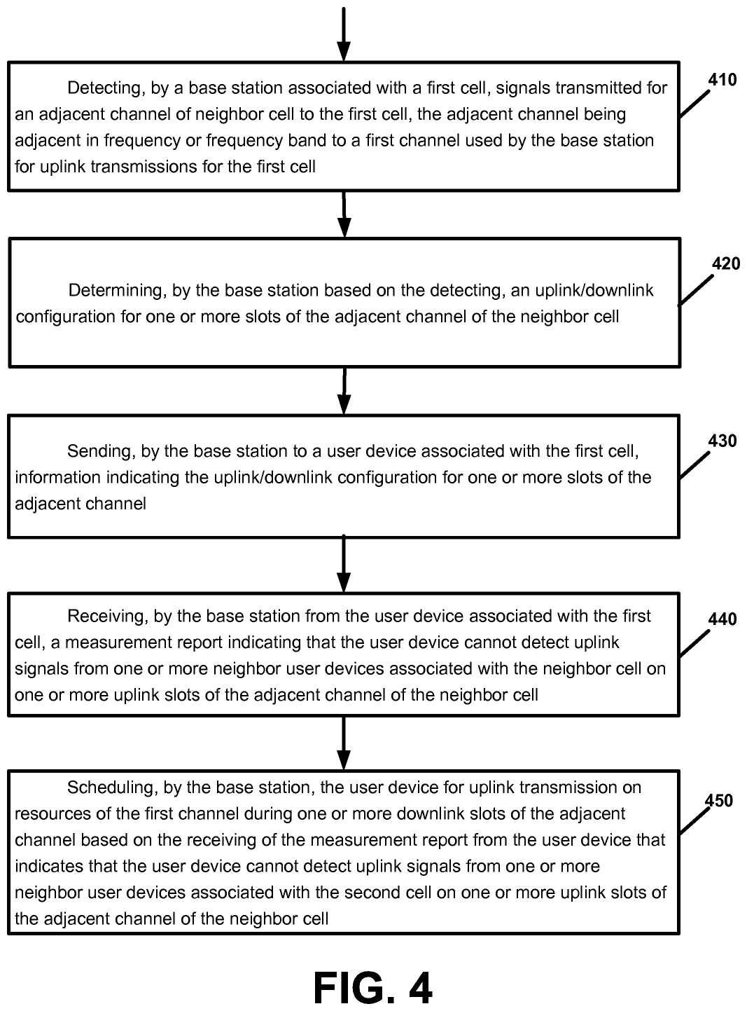

FIG. 4 is a flow chart illustrating operation of a base station according to an example implementation. Operation 410 includes detecting, by a base station associated with a first cell, signals transmitted for an adjacent channel of neighbor cell to the first cell, the adjacent channel being adjacent in frequency or frequency band to a first channel used by the base station for uplink transmissions for the first cell. Operation 420 includes determining, by the base station based on the detecting, an uplink/downlink configuration for one or more slots of the adjacent channel of the neighbor cell. Operation 430 includes sending, by the base station to a user device associated with the first cell, information indicating the uplink/downlink configuration for one or more slots of the adjacent channel. Operation 440 includes receiving, by the base station from the user device associated with the first cell, a measurement report indicating that the user device cannot detect uplink signals from one or more neighbor user devices associated with the neighbor cell on one or more uplink slots of the adjacent channel of the neighbor cell. And, operation 450 includes scheduling, by the base station, the user device for uplink transmission on resources of the first channel during one or more downlink slots of the adjacent channel based on the receiving of the measurement report from the user device that indicates that the user device cannot detect uplink signals from one or more neighbor user devices associated with the neighbor cell on one or more uplink slots of the adjacent channel of the neighbor cell.

Example 14 According to an example implementation of example 13, further comprising: determining, by the base station based on the uplink/downlink configuration determined by the base station, one or more slots of the adjacent channel where there are no downlink signals transmitted for the adjacent channel of the neighbor cell; and scheduling, by the base station, the user device for uplink transmission on resources of first channel during the one or more slots of the adjacent channel where there are no downlink signals transmitted for the adjacent channel of the neighbor cell.

### Example 15

According to an example implementation of any of examples 13-14, wherein the first channel comprises at least one of the following: a supplementary uplink channel used by the base station for uplink transmissions for the first cell; and a time-division duplex (TDD) channel with dynamic uplink/downlink allocations.

### Example 16

According to an example implementation of any of examples 13-15, wherein the first cell and the first channel are part of a first network for a first wireless operator, and the neighbor cell is part of a second network for a second wireless operator that is different from the first wireless operator.

### Example 17

An apparatus comprising at least one processor and at least one memory including computer instructions that, when executed by the at least one processor, cause the apparatus to perform a method of any of examples 13-16.

### Example 18

An apparatus comprising means for performing a method of any of examples 13-16.

### Example 19

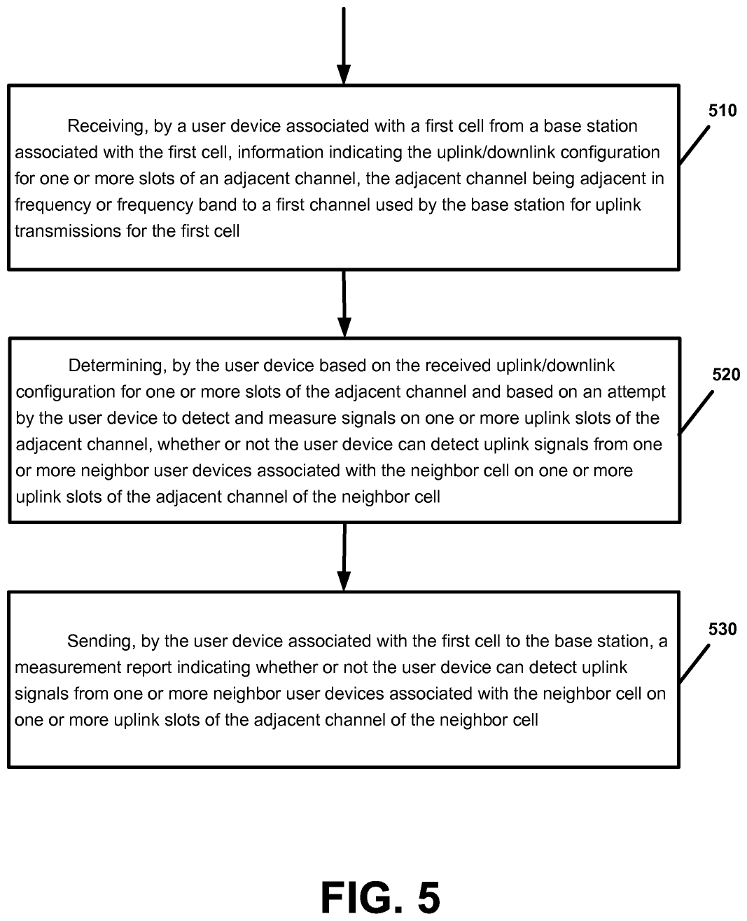

FIG. 5 is a flow chart illustrating operation of a user device according to an example implementation. Operation 510 includes receiving, by a user device associated with a first cell from a base station associated with the first cell, information indicating the uplink/downlink configuration for one or more slots of an adjacent channel, the adjacent channel being adjacent in frequency or frequency band to a first channel used by the base station for uplink transmissions for the first cell. Operation 520 includes determining, by the user device based on the received uplink/downlink configuration for one or more slots of the adjacent channel and based on an attempt by the user device to detect and measure signals on one or more uplink slots of the adjacent channel, whether or not the user device can detect uplink signals from one or more neighbor user devices associated with the neighbor cell on one or more uplink slots of the adjacent channel of the neighbor cell. And, operation 530 includes sending, by the user device associated with the first cell to the base station, a measurement report indicating whether or not the user device can detect uplink signals from one or more neighbor user devices associated with the neighbor cell on one or more uplink slots of the adjacent channel of the neighbor cell.

### Example 20

According to an example implementation of example 19, wherein the uplink/downlink configuration identifies at least one or more slots of the adjacent channel that are uplink slots and for which the user device should determine if the user device can detect uplink signals from the one or more neighbor user devices.

### Example 21

According to an example implementation of any of examples 19-20, wherein the determining comprises: determining, by the user device, that the user device cannot detect uplink signals from one or more neighbor user devices associated with the neighbor cell on one or more uplink slots of the adjacent channel of the neighbor cell.

### Example 22

According to an example implementation of any of examples 19-21, and further comprising: receiving, by the user device from the base station, either an uplink grant or an uplink configuration for a semi-static resource allocation, indicating resources of the first channel for uplink transmission during one or more downlink slots of the adjacent channel of the neighbor cell.

### Example 23

According to an example implementation of any of examples 19-22, and further comprising: receiving, by the user device from the base station, either an uplink grant or an uplink configuration for a semi-static resource allocation, indicating resources of the first channel for uplink transmission during one or more downlink slots and during one or more uplink slots of the adjacent channel of the neighbor cell if the user device cannot detect uplink signals from one or more neighbor user devices associated with the neighbor cell on one or more uplink slots of the adjacent channel of the neighbor cell.

### Example 24

According to an example implementation of any of examples 19-23, and further comprising: receiving, by the user device from the base station, either an uplink grant or an uplink configuration for a semi-static resource allocation, indicating resources of the first channel for uplink transmission only during one or more uplink slots, and not during one or more downlink slots, of the adjacent channel of the neighbor cell if the user device can detect uplink signals from one or more neighbor user devices associated with the neighbor cell on one or more uplink slots of the adjacent channel of the neighbor cell.

### Example 25

According to an example implementation of any of examples 19-24, wherein the first channel comprises at least one of the following: a supplementary uplink channel used by the base station for uplink transmissions for the first cell; and a time-division duplex (TDD) channel with dynamic uplink/downlink allocations.

### Example 26

According to an example implementation of any of examples 19-25, wherein the first cell and the first channel are part of a first network for a first wireless operator, and the neighbor cell is part of a second network for a second wireless operator that is different from the first wireless operator.

### Example 27

An apparatus comprising at least one processor and at least one memory including computer instructions that, when executed by the at least one processor, cause the apparatus to perform a method of any of examples 19-26.

### Example 28

An apparatus comprising means for performing a method of any of examples 19-26.

### Example 29

An apparatus comprising a computer program product including a non-transitory computer-readable storage medium and storing executable code that, when executed by at least one data processing apparatus, is configured to cause the at least one data processing apparatus to perform a method of any of examples 19-26.

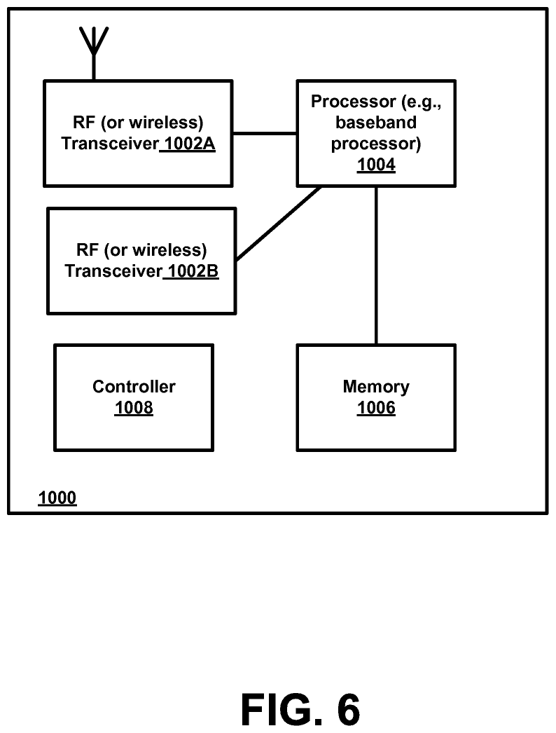

FIG. 6 is a block diagram of a wireless station (e.g., AP, BS, eNB, UE or user device) 1000 according to an example implementation. The wireless station 1000 may include, for example, one or two RF (radio frequency) or wireless transceivers 1002A, 1002B, where each wireless transceiver includes a transmitter to transmit signals and a receiver to receive signals. The wireless station also includes a processor or control unit/entity (controller) 1004 to execute instructions or software and control transmission and receptions of signals, and a memory 1006 to store data and/or instructions.

Processor 1004 may also make decisions or determinations, generate frames, packets or messages for transmission, decode received frames or messages for further processing, and other tasks or functions described herein. Processor 1004, which may be a baseband processor, for example, may generate messages, packets, frames or other signals for transmission via wireless transceiver 1002 (1002A or 1002B). Processor 1004 may control transmission of signals or messages over a wireless network, and may control the reception of signals or messages, etc., via a wireless network (e.g., after being down-converted by wireless transceiver 1002, for example). Processor 1004 may be programmable and capable of executing software or other instructions stored in memory or on other computer media to perform the various tasks and functions described above, such as one or more of the tasks or methods described above. Processor 1004 may be (or may include), for example, hardware, programmable logic, a programmable processor that executes software or firmware, and/or any combination of these. Using other terminology, processor 1004 and transceiver 1002 together may be considered as a wireless transmitter/receiver system, for example.

In addition, referring to FIG. 6, a controller (or processor) 1008 may execute software and instructions, and may provide overall control for the station 1000, and may provide control for other systems not shown in FIG. 6, such as controlling input/output devices (e.g., display, keypad), and/or may execute software for one or more applications that may be provided on wireless station 1000, such as, for example, an email program, audio/video applications, a word processor, a Voice over IP application, or other application or software.

In addition, a storage medium may be provided that includes stored instructions, which when executed by a controller or processor may result in the processor 1004, or other controller or processor, performing one or more of the functions or tasks described above.

According to another example implementation, RF or wireless transceiver(s) 1002A/1002B may receive signals or data and/or transmit or send signals or data. Processor 1004 (and possibly transceivers 1002A/1002B) may control the RF or wireless transceiver 1002A or 1002B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-29. (canceled)

30. A method of reducing interference with an adjacent channel, the method comprising:
determining, by a base station associated with a first cell, an uplink/downlink configuration for one or more slots of an adjacent channel of a neighbor cell, the adjacent channel being adjacent in frequency or frequency band to a first channel used by the base station for uplink transmissions for the first cell;
receiving, by the base station from a user device associated with the first cell, a measurement report indicating whether or not the user device can detect uplink signals from one or more neighbor user devices associated with the neighbor cell on one or more uplink slots of the adjacent channel of the neighbor cell;
determining, by the base station based on the uplink/downlink configuration determined by the base station, slots of the adjacent channel where there are no downlink signals transmitted for the adjacent channel;
scheduling, by the base station, the user device for uplink transmission on resources of the first channel during the one or more slots of the adjacent channel where there are no downlink signals transmitted for the adjacent channel of the neighbor cell; and
scheduling, by the base station, the user device for uplink transmission on resources of the first channel during one or more downlink slots of the adjacent channel if the measurement report from the user device indicates that the user device cannot detect uplink signals from one or more neighbor user devices associated with the neighbor cell on one or more uplink slots of the adjacent channel of the neighbor cell.

31. The method of claim 30, wherein the measurement report received from the user device is based on user device signal measurements of one or more uplink slots of the adjacent channel, wherein uplink slots of the adjacent channel are indicated based on uplink/downlink configuration of the adjacent channel that is either detected by the user device or sent by the base station to the user device.

32. The method of claim 30, wherein the scheduling, by the base station, the user device for uplink transmission on resources of the first channel during the one or more slots of the adjacent channel where there are no downlink signals transmitted for the adjacent channel of the neighbor cell comprises:
scheduling, by the base station, the user device for uplink transmission on resources of the first channel during one or more uplink slots of the adjacent channel.

33. The method of claim 30, wherein the first channel comprises at least one of the following:
a supplementary uplink channel used by the base station for uplink transmissions for the first cell; and
a time-division duplex (TDD) channel with dynamic uplink/downlink allocations.

34. The method of claim 30, wherein the determining an uplink/downlink configuration for one or more slots of an adjacent channel of a neighbor cell comprises:
determining, for one or more slots of the adjacent channel of the neighbor cell, whether the slot is an uplink slot or a downlink slot.

35. The method of claim 30, wherein the determining an uplink/downlink configuration for one or more slots of the adjacent channel of the neighbor cell comprises:
detecting, by the base station associated with the first cell, signals transmitted for the adjacent channel of the neighbor cell; and
determining, by the base station based on the detecting, an uplink/downlink configuration for one or more slots of the adjacent channel of the neighbor cell.

36. The method of claim 30, wherein the determining an uplink/downlink configuration for one or more slots of the adjacent channel of the neighbor cell comprises:
receiving by the base station from the user device, a measurement report including uplink/downlink information with respect to the adjacent channel of the neighbor cell.

37. The method of claim 30, further comprising:
sending, by the base station to the user device associated with the first cell, information indicating the uplink/downlink configuration for one or more slots of the adjacent channel.

38. The method of claim 30, wherein the first cell and the first channel are part of a first network for a first wireless operator, and the neighbor cell is part of a second network for a second wireless operator that is different from the first wireless operator.

39. An apparatus comprising at least one processor and at least one memory including computer instructions that, when executed by the at least one processor, cause the apparatus to perform a method of claim 30.

40. A method of reducing interference with an adjacent channel, the method comprising:
receiving, by a user device associated with a first cell from a base station associated with the first cell, information indicating the uplink/downlink configuration for one or more slots of an adjacent channel, the adjacent channel being adjacent in frequency or frequency band to a first channel used by the base station for uplink transmissions for the first cell;
determining, by the user device based on the received uplink/downlink configuration for one or more slots of the adjacent channel and based on an attempt by the user device to detect and measure signals on one or more uplink slots of the adjacent channel, whether or not the user device can detect uplink signals from one or more neighbor user devices associated with the neighbor cell on one or more uplink slots of the adjacent channel of the neighbor cell;
receiving, by the user device from the base station, either an uplink grant or an uplink configuration for a semi-static resource allocation, indicating resources of the first channel for uplink transmission during one or more downlink slots and during one or more uplink slots of the adjacent channel of the neighbor cell if the user device cannot detect uplink signals from one or more neighbor user devices associated with the neighbor cell on one or more uplink slots of the adjacent channel of the neighbor cell; and
sending, by the user device associated with the first cell to the base station, a measurement report indicating whether or not the user device can detect uplink signals from one or more neighbor user devices associated with the neighbor cell on one or more uplink slots of the adjacent channel of the neighbor cell.

41. The method of claim 40, wherein the uplink/downlink configuration identifies at least one or more slots of the adjacent channel that are uplink slots and for which the user device should determine if the user device can detect uplink signals from the one or more neighbor user devices.

42. The method of claim 40, wherein the determining comprises:
determining, by the user device, that the user device cannot detect uplink signals from one or more neighbor user devices associated with the neighbor cell on one or more uplink slots of the adjacent channel of the neighbor cell.

43. The method of claim 42, further comprising:
receiving, by the user device from the base station, either an uplink grant or an uplink configuration for a semi-static resource allocation, indicating resources of the first channel for uplink transmission during one or more downlink slots of the adjacent channel of the neighbor cell.

44. The method of claim 40, further comprising:
receiving, by the user device from the base station, either an uplink grant or an uplink configuration for a semi-static resource allocation, indicating resources of the first channel for uplink transmission only during one or more uplink slots, and not during one or more downlink slots, of the adjacent channel of the neighbor cell if the user device can detect uplink signals from one or more neighbor user devices associated with the neighbor cell on one or more uplink slots of the adjacent channel of the neighbor cell.

45. The method of claim 40, wherein the first channel comprises at least one of the following:
a supplementary uplink channel used by the base station for uplink transmissions for the first cell; and
a time-division duplex (TDD) channel with dynamic uplink/downlink allocations.

46. The method of claim 40, wherein the first cell and the first channel are part of a first network for a first wireless operator, and the neighbor cell is part of a second network for a second wireless operator that is different from the first wireless operator.

47. An apparatus comprising at least one processor and at least one memory including computer instructions that, when executed by the at least one processor, cause the apparatus to perform a method of claim 40.
